(19) United States
(12) Patent Application Publication
(10) Pub. No.: US 2004/0244527 A1
(43) Pub. Date: Dec. 9, 2004

(54) Direct drive adjustable pedal system with step-over control

(76) Inventors: Christopher Rixon, Warren, MI (US); Jiyuan Ouyang, Windsor (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/457,255

(22) Filed: Jun. 9, 2003

(51) Int. Cl. G05G 1/14

(52) U.S. Cl. 74/560

(57) ABSTRACT

An adjustable pedal assembly (10) for controlling step-over between adjacent pedal levers (18,32). A first pedal lever (18) is supported for rotation about an operational axis (A). A first adjustment mechanism (20) includes a first motor (26) to adjust the first pedal lever (18) between a first plurality of adjusted positions. A second pedal lever (32) is supported for rotation about a second operational axis (B). A second adjustment mechanism (40) includes a second motor (48) to adjust the second pedal lever (32) between a second plurality of adjusted positions. Each of the motors (26,48) is a brushless DC motor comprising a motor shaft (54,60), a plurality of sensors (H1,H1′,H2,H2′,H3,H3′) adjacent to the motor shaft (54,60), and a plurality of windings (W) surrounding the motor shaft (54,60). The plurality of sensors (H1,H1′,H2,H2′,H3,H3′)of each motor (26,48) generates a position signal indicating a position of each motor (26,48). When the position signals are unequal, step-over has occurred. In response, a coordinator (66) repositions at least one of the motor shafts (54,60) by holding an output signal sent to phases (A,B,C) of the windings (W) at a steady state until the position signals are equal.

### FIELD OF THE INVENTION

The present invention relates to an adjustable pedal assembly and a method for controlling step-over between pedal levers in the adjustable pedal assembly.

### BACKGROUND OF THE INVENTION

Adjustable pedal assemblies are well known for use in a vehicle to provide a driver of the vehicle with a means to adjust a distance between the driver and pedal levers used to control the vehicle. A typical adjustable pedal assembly comprises a support for mounting the adjustable pedal assembly to the vehicle. A first pedal lever, such as an accelerator pedal lever, is pivotally supported for rotation about an operational axis relative to the support. A first adjustment mechanism adjusts the first pedal lever between a first plurality of adjusted positions relative to the support. A second pedal lever, such as a brake pedal lever, is pivotally supported for rotation about a second operational axis relative to the support. A second adjustment mechanism adjusts the second pedal lever between a second plurality of adjusted positions relative to the support. As will be appreciated by those skilled in the art, the first and second adjustment mechanisms each comprise a transmission connected to a drive screw to rotate the drive screw and a nut that is moved axially along a guide by the drive screw. A single motor is connected in series to the transmissions by a pair of rotary cables. The motor drives the transmissions to rotate the drive screws to adjust both pedal levers between the adjusted positions. Such a system is shown in U.S. Pat. No. 5,722,302 to Rixon et al. and U.S. Pat. No. 5,964,125 to Rixon et al.

As adjustable pedal assemblies have developed over the last several years, regulations and specifications concerning their use have also developed. One such specification is that of minimizing pedal lever “step-over.” Step-over occurs when the first and second pedal levers become misaligned during adjustment. When the pedal levers are misaligned, the driver may have difficulty quickly adjusting to the relative positions of the first and second levers. As a result, there has come a need in the art to minimize pedal lever step-over.

Methods for controlling pedal lever step-over in adjustable pedal assemblies are suggested in U.S. Pat. No. 6,352,007 to Zhang et al., U.S. Pat. No. 6,450,061 to Chapman et al., and U.S. Pat. No. 6,510,761 to Zhang et al. In each of these patents, sensors are utilized to detect when step-over occurs between two or more pedal levers during adjustment. Specifically referring to the '007 and the '761 patents, both to Zhang et al., sensors are positioned adjacent to the drive screws to directly sense rotation of the drive screws to detect step-over. In each of these patents, when step-over occurs, power to the motor is discontinued and adjustment of the pedal levers ceases. Hence, there remains a need in the art for an adjustable pedal assembly that can compensate for step-over without discontinuing power to the motor.

### BRIEF SUMMARY OF THE INVENTION AND ADVANTAGES

The present invention provides an adjustable pedal assembly comprising a first support portion. A first pedal lever is supported by the first support portion for rotation about an operational axis relative to the first support portion. The first support portion also supports a first adjustment mechanism. The first adjustment mechanism includes a first motor having a first motor shaft to adjust the first pedal lever between a first plurality of adjusted positions relative to the first support portion. A second support portion is near the first support portion. A second pedal lever is supported by the second support portion for rotation about a second operational axis relative to the second support portion. The second support portion also supports a second adjustment mechanism. The second adjustment mechanism includes a second motor having a second motor shaft to adjust the second pedal lever between a second plurality of adjusted positions relative to the second support portion. A controller is programmed to operate the first and second motors to simultaneously move the first and second pedal levers between the adjusted positions. The controller is also programmed to detect step-over between the pedal levers. The controller includes a coordinator to reposition at least one of the motors to a corrected position in response to the step-over. In this manner, the coordinator repositions at least one of the pedal levers relative to the other to maintain a predetermined relationship between the pedal levers thereby controlling step-over between the first and second pedal levers. The adjustable pedal assembly is characterized by the first motor including at least one sensor adjacent the first motor shaft to sense rotation of the first motor shaft and transmit a first position signal that varies as the first motor shaft rotates and the second motor including at least one sensor adjacent the second motor shaft for sensing rotation of the second motor shaft and transmitting a second position signal that varies as the second motor shaft rotates. The sensors are used to detect the step-over.

The present invention also provides a method of operating the adjustable pedal assembly to control step-over between the first and second pedal levers. The method includes operating the first and second motors simultaneously to move the first and second pedal levers simultaneously through the adjusted positions. As the first and second motors operate, a first position signal is transmitted to the coordinator whereby the first position signal varies as the first motor operates. In addition, a second position signal is transmitted to the coordinator whereby the second position signal varies as the second motor operates. As these position signals are being transmitted, a comparator compares the first and second position signals. The method of operating the adjustable pedal system to control step-over is characterized by repositioning at least one of the motors to a corrected position in response to the position signals of the first and second motors being unequal. By doing so, the predetermined relationship between the pedal levers can be maintained as the pedal levers move between the adjusted positions.

The present invention provides several advantages over the prior art. Notably, the present invention allows adjustment of the pedal levers between the adjusted positions while immediately reacting to reposition the pedal levers in the event of step-over between the pedal levers. While prior art systems have the ability to recognize the step-over, they do not compensate for the step-over. Instead, prior art systems simply monitor for step-over and discontinue adjustment when the step-over has occurred. The present invention provides the coordinator to minimize the potential of critical step-over events by repositioning at least one of the motors in the event of step-over thereby continually re-aligning the pedal levers during adjustment and maintaining the predetermined relationship during adjustment.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a perspective view of an adjustable pedal assembly of the present invention;

FIG. 2 is a perspective view of a first adjustment mechanism of the adjustable pedal assembly;

FIG. 2A is a perspective view of a second adjustment mechanism of the adjustable pedal assembly;

FIG. 3 is a perspective view of a first motor of the first adjustment mechanism;

FIG. 3A is a perspective view of a second motor of the second adjustment mechanism;

FIG. 4 is a schematic illustration of a control system for the adjustable pedal assembly;

FIG. 5 is a truth table illustrating a six-step commutation process of the motors of the adjustable pedal assembly;

FIG. 6A is the schematic illustration of the control system of FIG. 4 further illustrating a first step of the commutation process;

FIG. 6B is the schematic illustration of the control system of FIG. 4 further illustrating a second step of the commutation process;

FIG. 6C is the schematic illustration of the control system of FIG. 4 further illustrating step-over occurring between the first step and the second step of the commutation process;

FIG. 7 is a graph illustrating the six-step commutation process of the motors of the adjustable pedal assembly during normal operation and when step-over occurs; and

FIG. 8 is a schematic illustration generally showing an alternative configuration of the first and second motors.

### DETAILED DESCRIPTION OF THE INVENTION

Referring to the Figures, wherein like numerals indicate like or corresponding parts throughout the several views, an adjustable pedal assembly is generally shown at 10. First and second support portions, generally indicated at 12 and 14, are included for mounting the adjustable pedal assembly 10 to a vehicle 16.

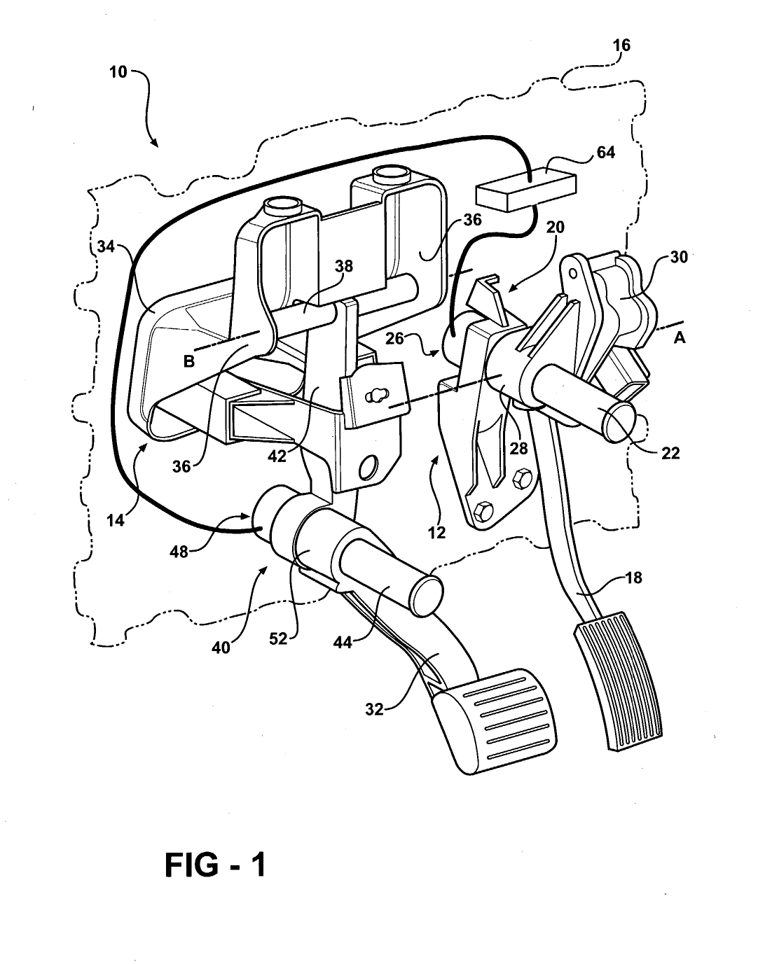

Referring to FIG. 1, a first pedal lever 18 is supported by the first support portion 12 for rotation about an operational axis (A) relative to the first support portion 12. A first adjustment mechanism 20, which is also supported by the first support portion 12, interconnects the first support portion 12 and the first pedal lever 18. The first adjustment mechanism 20 adjusts the first pedal lever 18 between a first plurality of adjusted positions relative to the first support portion 12.

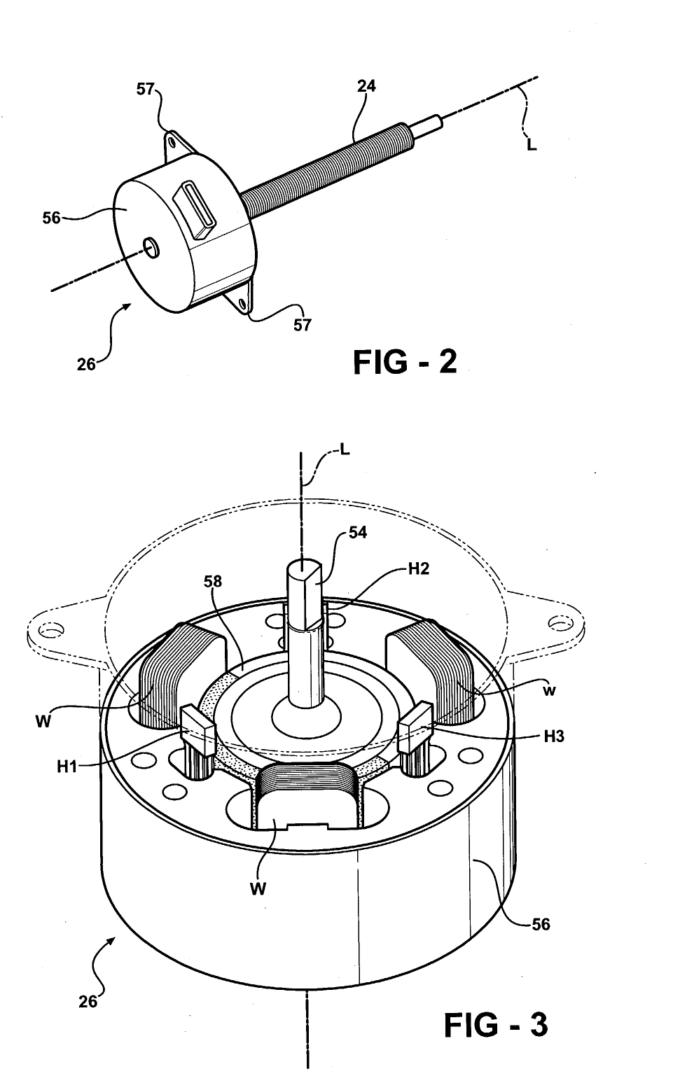

The first adjustment mechanism 20 includes a guide 22, in the form of a rod 22 supported by the first support portion 12. The rod 22 is hollow, and a nut (not shown) is moved axially within the rod 22 by a first drive screw 24, as shown in FIG. 2. A first motor 26 rotates the first drive screw 24 within the rod 22 to move the nut along the first drive screw 24 to adjust the first pedal lever 18 between the first plurality of adjusted positions. Such an assembly is illustrated in U.S. Pat. No. 5,722,302 to Rixon et al. and U.S. Pat. No. 5,964,125 to Rixon et al., herein incorporated by reference. However, as will be appreciated, the guide 22 may take the form of a plate that slidably supports the first pedal lever 18, the plate being either slidable or rotatable relative to the first support portion 12.

A collar 28 is slidably supported by the rod 22 and carries the first pedal lever 18. A pin (not shown) pivotally supports the first pedal lever 18 for rotation about the operational axis (A) relative to the collar 28. As shown in FIG. 1, the first pedal lever 18 is an accelerator pedal, which utilizes an electrical generator 30, e.g., pedal position sensor such as a potentiometer, a hall-effect sensor, etc., attached to the collar 28 to actuate a throttle (not shown) for the vehicle 16. The electrical generator 30 is well known to those skilled in the art for sending a control signal to the throttle that varies as the first pedal lever 18 rotates about the operational axis (A). It should be appreciated that a mechanical actuator could also be employed.

Still referring to FIG. 1, a second pedal lever 32 is supported by the second support portion 14 for rotation about a second operational axis (B) relative to the second support portion 14. The second support portion 14 is positioned near the first support portion 12. The first 12 and second 14 support portions are separate structures mounted to the vehicle 16. However, in alternative embodiments, the first 12 and second 14 support portions may be part of a single, unitary structure. The second support portion 14 comprises a bracket 34 having side flanges 36 that rotatably support a shaft 38. A second adjustment mechanism 40, which is also supported by the second support portion 14, is pivotally supported by the shaft 38. More specifically, the shaft 38 supports an arm 42 that supports the second adjustment mechanism 40. The second adjustment mechanism 40 interconnects the arm 42 and the second pedal lever 32 to adjust the second pedal lever 32 between a second plurality of adjusted positions.

The second adjustment mechanism 40 includes a guide 44, in the form of a rod 44, supported by the arm 42. The rod 44 is hollow and a nut (not shown) is moved axially within the rod 44 by a second drive screw 46, as shown in FIG. 2A. A second motor 48 rotates the second drive screw 46 within the rod 44 to move the nut along the second drive screw 46 to adjust the second pedal lever 32 between a second plurality of adjusted positions relative to the second support portion 14. The second drive screw 46 and nut arrangement can be like that shown in the aforementioned Rixon et al. patents.

A link (not shown) depends from the shaft 38 or arm 42 and supports an attachment (not shown) that connects to a vehicle system (not shown) for operating the system, e.g., a brake system. As is well known in the art, anyone of the shaft 38, arm 42, or link could be connected to an electrical generator, e.g., pedal position sensor such as a potentiometer, hall-effect sensor, etc, for sending a control signal to a vehicle system. A collar 52 is slidably supported by the rod 44 and connected to the second pedal arm 42 to carry the second pedal arm 42 between the second plurality of adjusted positions along the rod 44.

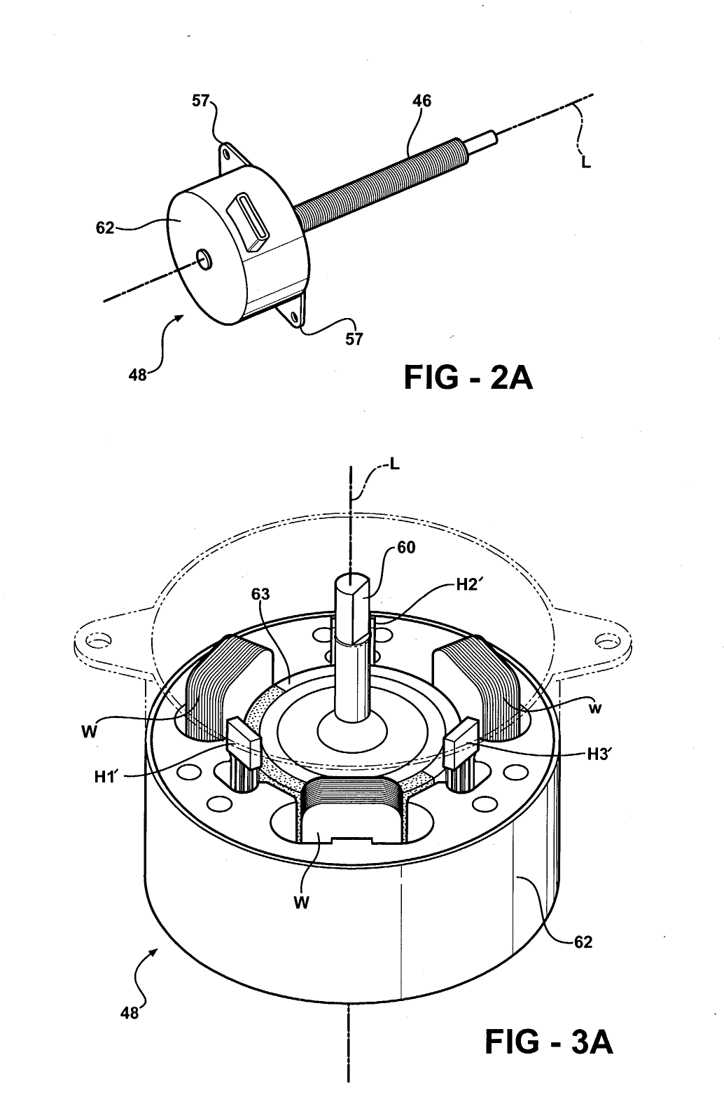

Referring to FIGS. 2 and 3, the first motor 26 includes a first motor shaft 54 and a first motor housing 56 surrounding the first motor shaft 54. A pair of ears 57 defining holes for fasteners extend from the first motor housing 56 to attach the first motor housing 56 to the first support portion 12. The first drive screw 24 extends from the first motor shaft 54. Hence, the first motor shaft 54 is directly connected to the first drive screw 24 to rotate the first drive screw 24 and adjust the first pedal lever 18. The first motor shaft 54 could be directly connected to the first drive screw 24 by several methods including welding, or by providing a coupling between the first motor shaft 54 and the first drive screw 24. Such a connection is shown in U. S. Pat. No. 4,989,474 to Cicotte et al., herein incorporated by reference. By being directly connected, the first motor shaft 54 and first drive screw 24 lie along a common longitudinal axis (L).

The first motor 26 is preferably a brushless DC motor. Brushless DC motors are well known to those skilled in the motor arts. However, brushless DC motors can assume a multitude of configurations and control schemes. Hence, the first motor 26 shall be described generally below and shall not be limited to the specific configuration and control scheme set forth.

Inside the first motor housing 56, a first plurality of sensors (H1,H2,H3) are positioned adjacent to the first motor shaft 54 for sensing rotation of the first motor shaft 54 and generating a first position signal whereby the first position signal varies as the first motor shaft 54 rotates. The first position signal indicates a current rotational position of the first motor shaft 54.

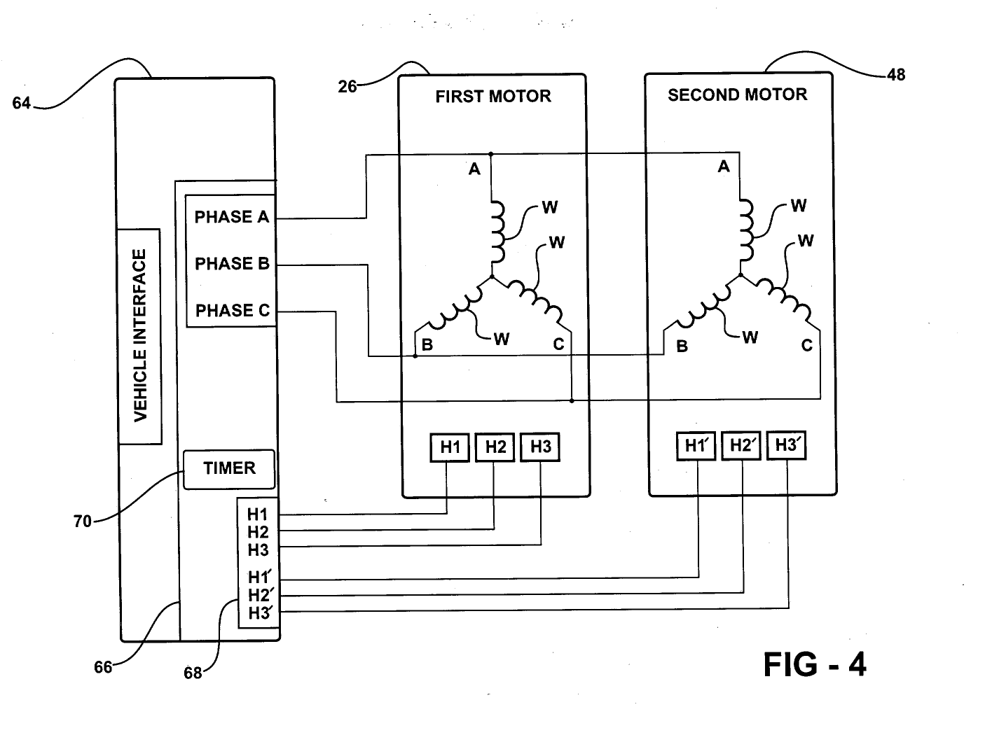

Referring to FIGS. 3 and 4, the first plurality of sensors (H1,H2,H3) are three hall-effect sensors (H1,H2,H3) that are disposed radially from the first motor shaft 54 at a position one hundred and twenty electrical degrees from one another. The first motor shaft 54 includes a permanent magnet 58 mounted thereto for rotation therewith and the hall-effect sensors (H1,H2,H3) are responsive to the permanent magnet 58 to generate the first position signal. The first position signal comprises control signals generated by each of the hall-effect sensors (H1,H2,H3) as the first motor shaft 54 rotates. It should be appreciated that the first plurality of sensors (H1,H2,H3) are not limited to hall-effect sensors, but could include other position sensors, back EMF signals, and the like to provide the first position signal.

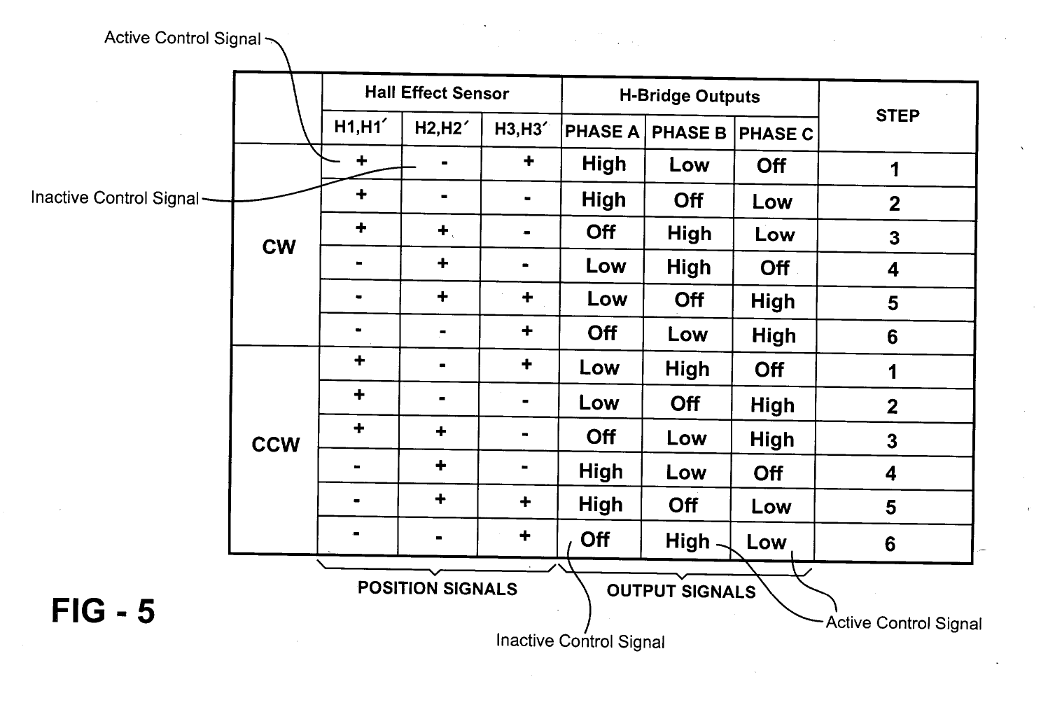

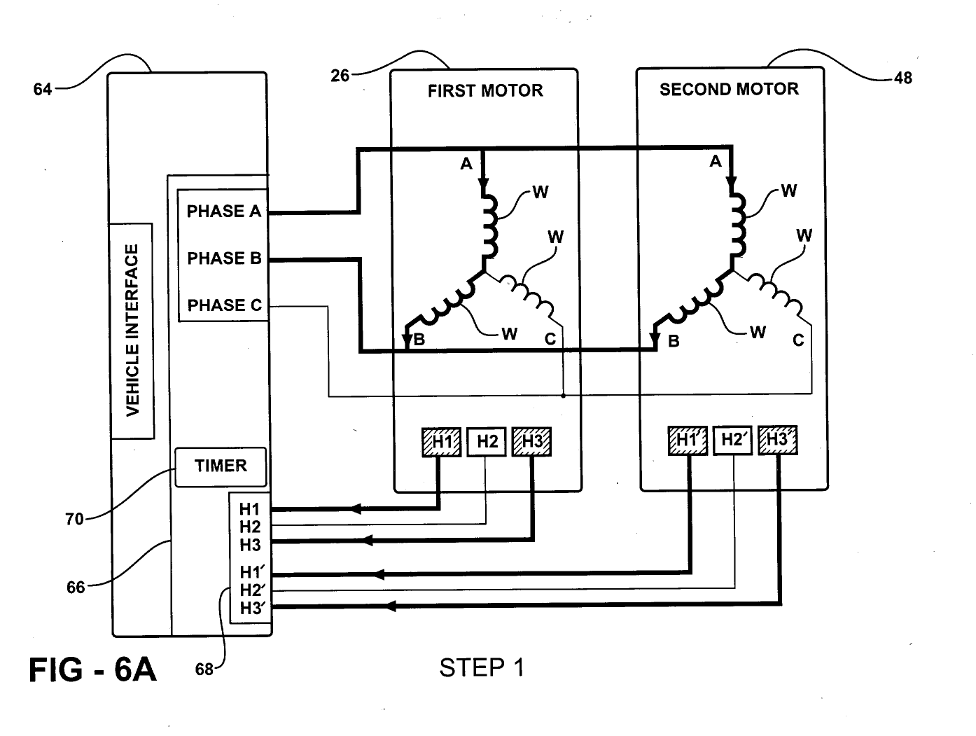

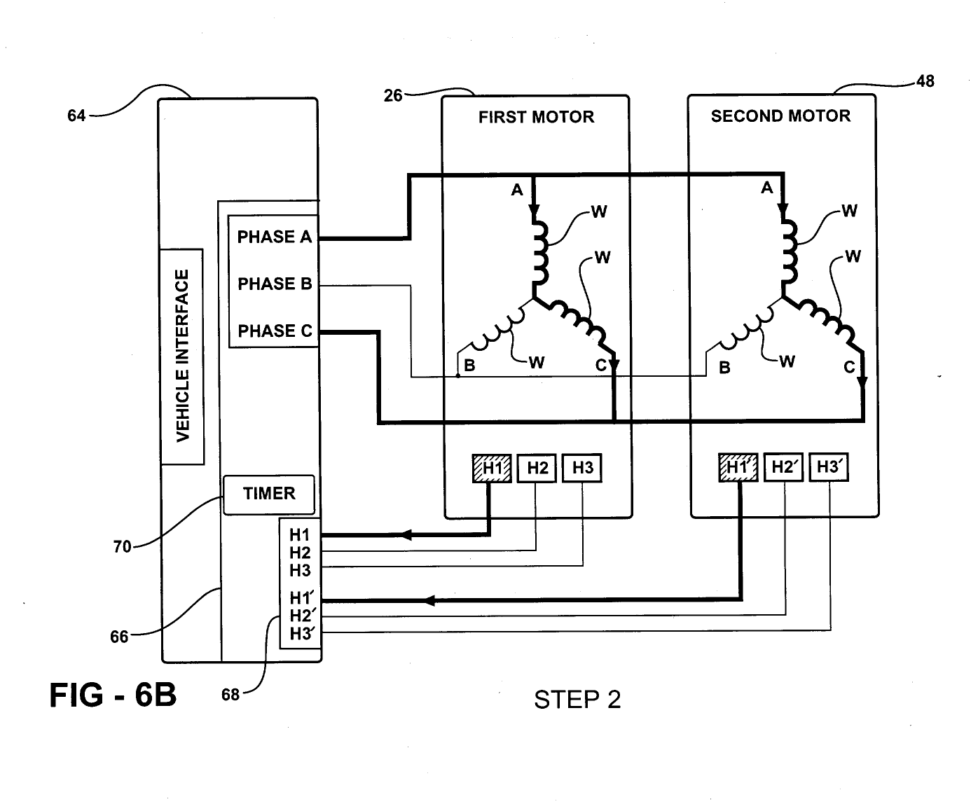

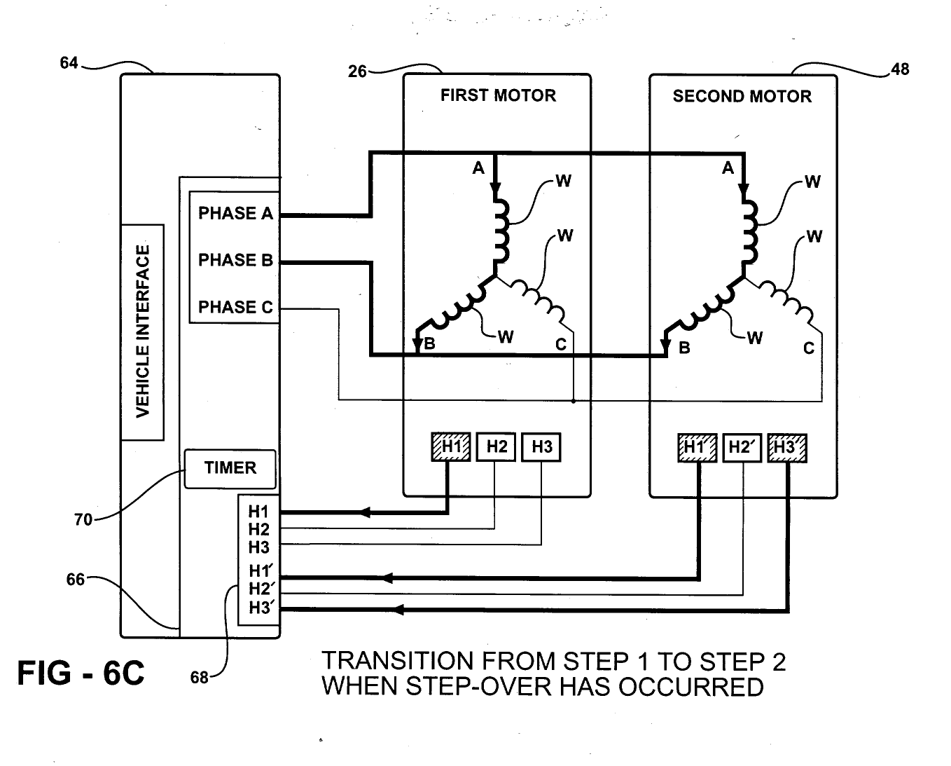

Referring to FIG. 3, the first motor 26 includes a first plurality of windings (W) surrounding the first motor shaft 54 in a Y configuration. Three phases (A,B,C) of the first plurality of windings (W), schematically shown in FIG. 4, are sequentially energized and de-energized in a plurality of steps to rotate the first motor shaft 54. More specifically, the three phases (A,B,C) are energized and de-energized in a six-step, square wave pattern. This is commonly referred to as six-step commutation. In each of the steps, indicated in a truth table of FIG. 5, each of the three phases (A,B,C) assume one of three states, including high (positive), low (negative), or off (zero). For instance, in step 1, phase A is in a high state, phase B is in a low state, and phase C is off. Current flows through the phases (A,B,C) from high to low, i.e., positive to negative. FIGS. 6A and 6B illustrate current flow from phase A to phase B in step 1, and from phase A to phase C in step 2, respectively. The truth table illustrates clockwise (CW) and counterclockwise (CCW) six-step commutation.

Referring to FIGS. 2A and 3A, the second motor 48 is identical to the first motor 26. The second motor 48 includes a second motor shaft 60 and a second motor housing 62 surrounding the second motor shaft 60. A pair of ears 57 defining holes for fasteners extend from the second motor housing 62 to attach the second motor housing 62 to the second support portion 14. The second drive screw 46 extends from the second motor shaft 60. Hence, the second motor shaft 60 is directly connected to the second drive screw 46 to rotate the second drive screw 46 and adjust the second pedal lever 32. The second motor shaft 54 could be directly connected to the second drive screw 24 by several methods including welding, or by providing a coupling between the second motor shaft 54 and the second drive screw 24. Such a connection is shown in U.S. Pat. No. 4,989,474 to Cicotte et al., herein incorporated by reference. By being directly connected, the second motor shaft 54 and second drive screw 24 lie along a common longitudinal axis (L).

Again, the second motor 48 is preferably a brushless DC motor and brushless DC motors can assume a multitude of configurations and control schemes. Hence, the second motor 48 shall be described generally below and shall not be limited to the specific configuration and control scheme set forth.

Inside the second motor housing 62, a second plurality of sensors (H1′,H2′,H3′) are adjacent to the second motor shaft 60 for sensing rotation of the second motor shaft 60 and generating a second position signal whereby the second position signal varies as the second motor shaft 60 rotates. The second position signal indicates a current rotational position of the second motor shaft 60.

Referring to FIGS. 3A and 4, the second plurality of sensors (H1′,H2′,H3′) are three hall-effect sensors (H1′,H2′,H3′) that are disposed radially from the second motor shaft 60 at a position one hundred and twenty electrical degrees from one another. The second motor shaft 60 includes a second permanent magnet 63 mounted thereto for rotation therewith and the hall-effect sensors (H1′,H2′,H3′) are responsive to the second permanent magnet 63 to generate the second position signal. The second position signal comprises control signals generated by each of the hall-effect sensors (H1′,H2′,H3′) as the second motor shaft 60 rotates. Again, it should be appreciated that the second plurality of sensors (H1′,H2′,H3′) are not limited to hall-effect sensors, but could include other position sensors, back EMF signals, and the like to provide the second position signal.

Referring to FIG. 3A, the second motor 48 includes a second plurality of windings (W) surrounding the second motor shaft 60 in a Y configuration. Three phases (A,B,C) of the second plurality of windings (W), also schematically shown in FIG. 4, are sequentially energized and de-energized in a plurality of steps to rotate the second motor shaft 60. More specifically, the three phases (A,B,C) are energized and de-energized in a six-step, square wave pattern, i.e., six-step commutation. In each of the steps, indicated in a truth table of FIG. 5, each of the three phases (A,B,C) assume one of three states, including high (positive), low (negative), or off (zero). For instance, in step 1, phase A is in a high state, phase B is in a low state, and phase C is off. Current flows through the phases (A,B,C) from high to low, i.e., positive to negative. FIGS. 6A and 6B illustrate current flow from phase A to phase B in step 1, and from phase A to phase C in step 2, respectively. The truth table illustrates clockwise (CW) and counterclockwise (CCW) six-step commutation.

A controller 64 is programmed to operate the first 26 and second 48 motors to simultaneously move the first 18 and second 32 pedal levers between the adjusted positions. The controller 64 includes a vehicle interface to integrate the controller 64 with a control system (not shown) of the vehicle 16. The controller 64 includes a coordinator 66, i.e., a separate programmable component of the controller 64, or code within the controller 64, for commutating the first 26 and second 48 motors. Referring to the schematic illustration in FIG. 4, the first 26 and second 48 motors are wired in series with the coordinator 66 such that the corresponding phases (A,B,C) of each motor 26,48 are sequentially and simultaneously energized and de-energized in the plurality of steps to rotate the first 54 and second 60 motor shafts. In essence, wiring the motors 26,48 in series with the coordinator 66 synchronizes commutation of each motor 26,48 in accordance with the truth table of FIG. 5. An output signal from the coordinator 66 is used to energize and de-energize the phases (A,B,C) of each motor 26,48 in accordance with the truth table of FIG. 5. The output signal comprises separate control signals for each corresponding phase (A,B,C) of the first 26 and second 48 motors, as schematically illustrated in FIG. 4.

Essentially, the first and second position signals act as switches for the coordinator 66 to move between the plurality of steps shown in the truth table of FIG. 5. When the hall-effect sensors (H1,H2,H3) of the first motor 26 and the hall-effect sensors (H1′,H2′,H3′) of the second motor 48 are transmitting control signals matching those indicated for each step in FIG. 5, the output signal for the corresponding step is transmitted. For instance, referring to step 1, when hall-effect sensors H1,H1′ and H3,H3′ are active (illustrated by+sign in the truth table) and hall-effect sensors H2,H2′ and inactive (illustrated by−sign in the truth table), the coordinator 66 transmits the output signal to both motors 26,48 in the form indicated, i.e., phase A is in a high state, phase B is in a low state, and phase C is off. This is illustrated in FIG. 6A using thick lines to note active signals.

The controller 64 is programed to detect step-over between the pedal levers. The controller 64 includes a comparator 68, i.e., a separate programmable component of the controller 64, or code within the controller 64, for receiving the first and second position signals and comparing the first and second position signals. When the first and second position signals are unequal, as illustrated in FIG. 6C, step-over between the first 18 and second 32 pedal levers has occurred. In other words, when the control signals being sent from the hall-effect sensors (H1,H2,H3) of the first motor 26 do not match the control signals being sent from the hall-effect sensors (H1′,H2′,H3′) of the second motor 48, the first 18 and second 32 pedal levers have fallen out of a predetermined alignment or relationship.

The coordinator 66 repositions at least one of the motors 26,48 to a corrected position in response to the comparator 68 detecting step-over between the pedal levers 18,32 thereby repositioning at least one of the pedal levers 18,32 relative to the other to maintain the predetermined relationship between the pedal levers 18,32. More specifically, the coordinator 66 repositions at least one of the motor shafts 54,60 to a corrected position in response to the first and second positions signals being unequal. The coordinator 66 is programmed to reposition at least one of the motor shafts 54,60 to the corrected position by holding the output signal used to sequentially energize and de-energize the phases (A,B,C) of the first 26 and second 48 motors at a steady state until the first and second position signals are equal. In other words, when step-over has occurred, i.e., the first and second position signals are unequal, the coordinator 66 does not change the output signal. More specifically, the output signal is frozen in one of the plurality of steps in the truth table of FIG. 5 until the control signals from the hall-effect sensors (H1,H2,H3,H1′,H2′,H3′) are equal. This is best illustrated in FIGS. 6A-6C.

In FIG. 6A, the output signal for step 1 is illustrated. The output signal comprises current being sent from the coordinator 66 to phase A and through phase B of both motors 26,48 when the first and second position signals are equal, i.e., the hall-effect sensors (H1,H2,H3,H1′,H2′,H3′) from each motor 26,48 are transmitting the same control signals. In FIG. 6B, the output signal for step 2 is illustrated. The output signal comprises current being sent from the coordinator 66 to phase A and through phase C of both motors 26,48 when the first and second position signals are equal. FIG. 6C illustrates the first 26 and second 48 motors transitioning between step 1 and step 2 in the instance in which step-over has occurred. In this instance, as previously described, the first and second position signals are not equal. Only hall-effect sensor H1 of the first motor 26 is transmitting an active control signal, while both hall-effect sensors H1 and H3 of the second motor 48 are transmitting active control signals. Hence, compared to the required control signals for steps 1 and 2, the first position signal is in accordance with step 2, while the second position signal is stuck in step 1. More specifically, the first motor shaft 54 is rotating properly, while the second motor shaft 60 has stalled. When this occurs, even though the first motor 26 is ready to move to step 2, the output signal is frozen, as shown in FIGS. 6A and 6C until the first and second position signals are equal, as shown in FIG. 6B.

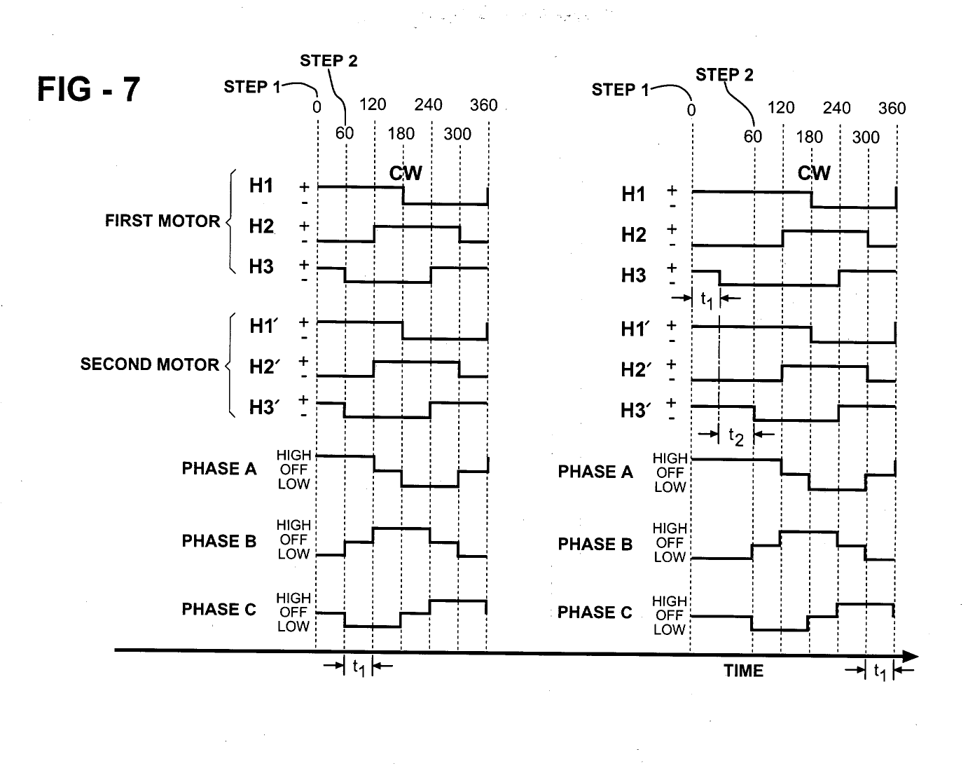

FIG. 7 further illustrates commutation of the first 26 and second 48 motors with no step-over, and commutation of the first 26 and second 48 motors when step-over has occurred. Commutation with no step-over is illustrated in the left portion of FIG. 7 and commutation with step-over is illustrated on the right. As shown in FIG. 7, during commutation with no step-over, a time t₁ between commutation steps is equal. Hence, the first 54 and second 60 motor shafts are rotating equally and uniformly. During commutation with step-over, a stall occurs that creates the step-over between pedal levers 18,32 by changing the rotation of the second motor shaft 60 relative to the first motor shaft 54. During step-over, as illustrated in the right side of FIG. 7, the control signal of hall-effect sensor H3 has changed in accordance with normal operation, but the control signal of hall-effect sensor H3′ has not. This illustration is in accordance with the illustration of FIGS. 6A-6C. Hence, the first and second position signals are not equal. In fact, additional time t₂ passes before the control signal of hall-effect sensor H3′ matches the control signal of hall-effect sensor H3. Therefore, the control signals sent to phases (A,B,C) of both motors 26,48 are frozen for the time t₂.

The controller 64 includes a timer 70 to measure the time t₂ that the position signals are unequal, i.e., the motor shafts 54,60 are in different positions, and for discontinuing the output signal sent to the windings (W) of both of the first 26 and second 48 motors in response to the time exceeding a predetermined limit thereby shutting down power to the motors 26,48.

The controller 64 may also be programmed to reset a predetermined position of the pedal levers 18,32 such as a full-forward position, to facilitate ingress and egress of a driver of the vehicle 16. The controller 64 utilizes the position signals generated by the sensors (H1,H1′,H2,H2′,H3,H3′), and signals from an ignition (not shown), and/or park switch (not shown) via the vehicle interface to operate the motors 26,48 to automatically move the pedal levers 18,32 to the full-forward position when the ignition is off and the park switch is on.

The controller 64 may also include a memory wherein the controller 64 utilizes signals from the ignition, the park switch, the sensors (H1,H1′,H2,H2′,H3,H3′), and memory buttons to operate the motors 26,48 to move the pedal levers 18,32 to a stored position in the memory when the memory button is depressed while the ignition is off and the park switch is on.

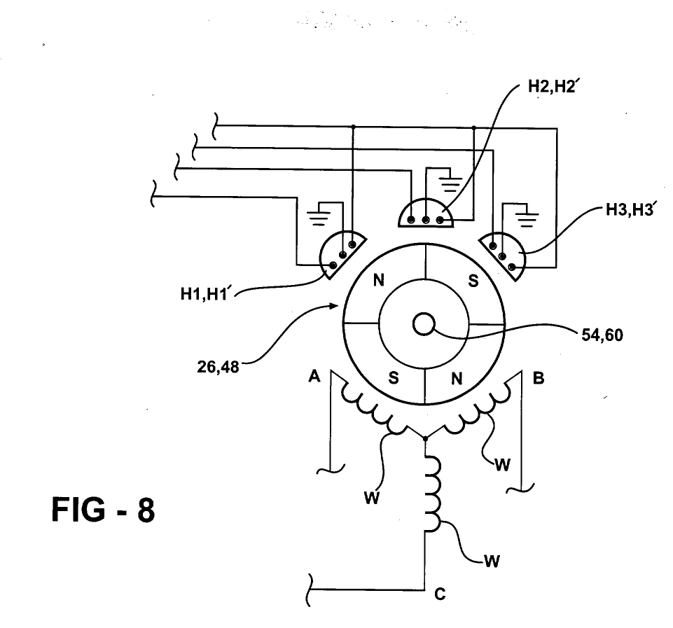

It should be appreciated that while the first 26 and second 48 motors are illustrated as three-phase, di-pole, brushless DC motors 26,48, the present invention should not be so limited. Other motors, keeping with the spirit of the present invention, could also be employed. For example, FIG. 8 schematically illustrates a general configuration for alternative first 26 and second 48 motors. In FIG. 8, the motors 26,48 are three-phase, four-pole motors, i.e., four magnet poles (N,S,N,S) are used to generate the position signals in conjunction with the hall-effect sensors (H1,H1′,H2,H2′,H3,H3′).

Operation of the adjustable pedal assembly 10 will now be described. To start, the first 26 and second 48 motors are operated to simultaneously move the first 18 and second 32 pedal levers through the first and second plurality of adjusted positions. Normal operation of the first 26 and second 48 motors, i.e., no step-over between the pedal levers 18,32, includes transmitting the output signal to the first 26 and second 48 motors by sequentially energizing the phases (A,B,C) of the windings (W) of the first 26 and second 48 motors to incrementally rotate the first 54 and second 60 motor shafts.

The first plurality of sensors (H1,H2,H3) transmits the first position signal to the comparator 68 during operation of the first motor 26. The second plurality of sensors (H1′,H2′,H3′) transmits the second position signal to the comparator 68 during operation of the second motor 48. The comparator 68 continuously compares the position signals. When the position signals are equal, there is no step-over between the pedal levers 18,32.

When the comparator 68 indicates that the first and second position signals are unequal, i.e., step-over between the pedal levers 18,32 has occurred, the coordinator 66 repositions at least one of the motors 26,48 to the corrected position thereby controlling the step-over and maintaining the predetermined relationship between the pedal levers 18,32 as the pedal levers 18,32 move between the adjusted positions. To reposition at least one of the motors 26,48 to the corrected position, the coordinator 66 holds the output signal at a steady state until the first and second position signals are equal. In other words, the output signal does not change to the next step in the commutation until the position signals are equal.

At the same time, the timer 70 is measuring the time t₂ that the position signals are unequal and responds by shutting down power to the motors 26,48 when the time has exceeded the predetermined limit.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. An adjustable pedal assembly (10) comprising;
a first support portion (12),
a first pedal (18) lever supported by said first support portion (12) for rotation about an operational axis (A) relative to said first support portion (12),
a first adjustment mechanism (20) supported by said first support portion (12) and including a first motor (26) having a first motor shaft (54) for adjusting said first pedal lever (18) between a first plurality of adjusted positions relative to said first support portion (12),
a second support portion (14) near said first support portion (12),
a second pedal lever (32) supported by said second support portion (14) for rotation about a second operational axis (B) relative to said second support portion (14),
a second adjustment mechanism (40) supported by said second support portion (14) and including a second motor (48) having a second motor shaft (60) for adjusting said second pedal lever (32) between a second plurality of adjusted positions relative to said second support portion (14), and
a controller (64) programmed for operating said first (26) and second (48) motors to simultaneously move said first (18) and second (32) pedal levers between said adjusted positions and for detecting a stall of at least one of said motors (26,48), said controller (64) having a coordinator (66) for repositioning at least one of said motors (26,48) to a corrected position in response to the stall of at least one of said motors (26,48) thereby repositioning at least one of said pedal levers (18,32) relative to the other to maintain a predetermined relationship between said pedal levers (18,32),
said assembly characterized by said first motor (26) including at least one sensor (H1,H2,H3) adjacent said first motor shaft (54) for sensing rotation of said first motor shaft (54) and transmitting a first position signal that varies as said first motor shaft (54) rotates and said second motor (48) including at least one sensor (H1′,H2′,H3′) adjacent said second motor shaft (60) for sensing rotation of said second motor shaft (60) and transmitting a second position signal that varies as said second motor shaft (60) rotates.

2. An assembly as set forth in claim 1 wherein said controller (64) includes a comparator (68) for receiving the first and second position signals and comparing the first and second position signals whereby said coordinator (66) repositions at least one of said motor shafts (54,60) to a corrected position in response to the first and second positions signals being unequal.

3. An assembly as set forth in claim 2 wherein each of said motor shafts (54,60) include a permanent magnet (58,63) mounted thereto for rotation therewith and said at least one sensors (H1,H1′,H2,H2′,H3,H3′) adjacent said first (54) and second (60) motor shafts are further defined as first (H1,H2,H3) and second (H1′,H2′,H3′) pluralities of hall-effect sensors responsive to said permanent magnets (58,63).

4. An assembly as set forth in claim 2 wherein said first motor (26) includes a first plurality of windings (W) surrounding said first motor shaft (54) whereby said coordinator (66) sends an output signal to phases (A,B,C) of said first plurality of windings (W) to incrementally rotate said first motor shaft (54).

5. An assembly as set forth in claim 4 wherein said second motor (48) includes a second plurality of windings (W) surrounding said second motor shaft (60) whereby said coordinator (66) sends the output signal to phases (A,B,C) of said second plurality of windings (W) to incrementally rotate said second motor shaft (60).

6. An assembly as set forth in claim 5 wherein said controller (64) includes a timer (70) for measuring a time (t₂) that the position signals are unequal and for discontinuing the output signal sent to said windings (W) of both of said first (26) and second (48) motors in response to the time (t₂) exceeding a predetermined limit.

7. An assembly as set forth in claim 6 wherein each of said adjustment mechanisms (20,40) includes a drive screw (24,46) for moving said pedal levers (18,32) between the adjusted positions.

8. An assembly as set forth in claim 7 wherein each of said motors (26,48) includes a motor housing (56,62) surrounding said motor shafts (54,60) and said drive screw (24,46) of each of said adjustment mechanisms (20,40) extend from said motor shafts (54,60).

9. An adjustable pedal assembly comprising;
a first support portion (12),
a first pedal lever (18) supported by said first support portion (12) for rotation about an operational axis (A) relative to said first support portion (12),
a first adjustment mechanism (20) supported by said first support portion (12) and including a first motor (26) and a first drive screw (24) extending from said first motor (26) wherein said first motor (26) includes a first motor shaft (54) with three hall-effect sensors (H1,H2,H3) adjacent said first motor shaft (54) and three windings (W) in a Y configuration surrounding said first motor shaft (54),
a second support (14) portion near said first support portion (12),
a second pedal lever (32) supported by said second support portion (14) for rotation about a second operational axis (B) relative to said second support portion (14),
a second adjustment mechanism (40) supported by said second support portion (14) and including a second motor (48) and a second drive screw (46) extending from said second motor (48) wherein said second motor (48) includes a second motor shaft (60) with three hall-effect sensors (H1′,H2′,H3′) adjacent said second motor shaft (60) and three windings (W) in a Y configuration surrounding said second motor shaft (60),
a controller (64) having a comparator (68) for receiving a first position signal comprising three control signals from said hall-effect sensors (H1,H2,H3) of said first motor (26) and a second position signal comprising three control signals from said hall-effect sensors (H1′,H2′,H3′) of said second motor (48) and for comparing the first and second position signals, and
said controller having a coordinator (66) for repositioning at least one of said motor shafts (54,60) to a corrected position in response to the first and second position signals being unequal thereby repositioning at least one of said pedal levers (18,32) relative to the other to control step-over between said pedal levers (18,32) and maintain a predetermined relationship between said pedal levers (18,32).

10. A method of operating an adjustable pedal assembly (10) comprising first (18) and second (32) pedal levers and first (26) and second (48) motors operatively connected to a controller (64) for moving the pedal levers (18,32) through a first and second plurality of adjusted positions, said method comprising the steps of;
transmitting an output signal to commutate the first (26) and second (48) motors and move the first (18) and second (32) pedal levers through the first and second plurality of adjusted positions,
transmitting a first position signal during transmission of the output signal whereby the first position signal varies as the first motor (26) commutates,
transmitting a second position signal during transmission of the output signal and the first position signal whereby the second position signal varies as the second motor (48) commutates, and
comparing the first and second position signals,
said method characterized by repositioning at least one of the motors (26,48) to a corrected position in response to the position signals being unequal thereby maintaining a predetermined relationship between the pedal levers (18,32) as the pedal levers (18,32) move between the adjusted positions.

11. A method as set forth in claim 10 wherein said step of transmitting the output signal further includes sequentially energizing phases (A,B,C) of a plurality of windings (W) of each of the first (26) and second (48) motors in a plurality of steps.

12. A method as set forth in claim 11 wherein said step of repositioning at least one of the motors (26,48) to the corrected position further includes holding the output signal at a steady state when the first and second position signals are unequal at least until the first and second position signals are equal.

13. A method as set forth in claim 12 further including changing the output signal in response to the first and second position signals being equal after holding the output signal at the steady state when the first and second position signals are unequal thereby continuing to move the first (18) and second (32) pedal levers while maintaining the predetermined relationship between the pedal levers (18,32).
